(19) United States
(12) Patent Application Publication
(10) Pub. No.: US 2020/0393785 A1
(43) Pub. Date: Dec. 17, 2020

(54) IMAGE FORMING DEVICE AND CONTROL METHOD

(71) Applicant: Konica Minolta Inc., Tokyo (JP)

(72) Inventors: Masayasu HAGA, Toyokawa-shi Aichi (JP); Tsugihito YOSHIYAMA, Toyohashi-shi Aichi (JP); Sayaka MORITA, Gamagori-shi Aichi (JP); Kunitomo SASAKI, Kotacho Nukatagun Aichi (JP)

(21) Appl. No.: 16/898,185

(22) Filed: Jun. 10, 2020

(30) Foreign Application Priority Data
Jun. 12, 2019 (JP) 2019-109560

(51) Int. Cl. G03G 15/00; G03G 21/00

(52) U.S. Cl. CPC G03G 15/5016; G03G 21/0094

(57) ABSTRACT

An image forming device that forms a toner image on a photosensitive drum 413, including a lubrication device 200 that applies lubricant to the photosensitive drum 413 and an operation panel 20. The image forming device acquires spring mounting times 108d that indicate lubrication performance of the lubrication device 200, compares the spring mounting times 108d to a threshold value, and when the spring mounting times 108d exceed the threshold value, displays guidance on the operation panel 20 prompting an operation to restore lubrication performance of the lubrication device 200.

This application claims priority to Japanese Patent Application No. 2019-109560 filed Jun. 12, 2019, the contents of which are hereby incorporated herein by reference in their entirety.

### BACKGROUND

### Technical Field

The present disclosure relates to image forming devices that apply lubricant to an image carrier.

### Related Art

Image forming devices such as electrophotographic printers charge a photosensitive drum, expose the charged photosensitive drum to form an electrostatic latent image, and develop the electrostatic latent image to form a toner image. The toner image is then transferred to a recording sheet, and residue such as toner that is not transferred to the recording sheet and remains on the photosensitive drum is then cleaned off.

Such image forming devices often have a structure in which a lubricant such as zinc stearate is applied to the photosensitive drum in order to improve transfer and cleaning performance.

According to JP 2017-9988, in a lubricant application unit that scrapes off a solid lubricant with a brush roller and supplies the lubricant to a surface of a photosensitive drum, displacement of a lubricant holding member that holds the lubricant is measured by a distance sensor. Actual consumption of lubricant is obtained in terms of lubricant per unit distance travelled by the photosensitive drum, and the actual consumption is compared to a preset reference consumption per unit distance. If the actual consumption exceeds a reference consumption amount, rotation speed of the brush roller is reduced, and if the actual consumption falls below the reference consumption amount, rotation speed of the brush roller is increased. As a result, an amount of lubricant supplied to the photosensitive drum is made uniform.

JP 2007-225847 and JP 2013-20232 also describe detecting a remaining amount of solid lubricant, and controlling a supply amount of the lubricant based on the detection result.

Further, J P 2017-9988, JP 2013-20232, JP 3406099, JP 2007-193263, and JP 2008-180789 describe a solid lubricant being pushed against a brush roller by a pressure member such as a spring so that an amount of scraping by the brush roller is constant.

### SUMMARY

A member such as a spring that pushes a solid lubricant against a brush roller deteriorates over long-term use, decreasing the force pushing the lubricant against the brush roller. For this reason, lubricant supplied to the photosensitive drum decreases, meaning that toner remaining on the photosensitive drum is not sufficiently cleaned off, leading to a problem that image quality deteriorates for the next image formed.

An object of the present disclosure is to provide an image forming device and a control method thereof capable of preventing deterioration of image quality for successive images even when lubrication performance of a lubrication device applying lubricant to an image carrier decreases due to long-term usage.

To achieve at least one of the abovementioned objects, according to an aspect of the present disclosure, an image forming device reflecting one aspect of the present disclosure is an image forming device that forms a toner image on an image carrier, including a lubrication device that applies lubricant to the image carrier, a display, a hardware processor and a non-transitory computer-readable recording medium comprising computer-executable instructions. When the instructions are executed by the hardware processor, they are configured to cause the image forming device to: acquire a parameter that indicates lubrication performance of the lubrication device, compare the parameter to a threshold value, and when the parameter exceeds the threshold value, display guidance on the display prompting an operation to restore lubrication performance of the lubrication device.

According to at least one embodiment, the lubrication device includes the lubricant in a form of a solid block, a lubricant supplier, and a pressing member that presses the solid block against the lubricant supplier. The lubricant supplier scrapes the lubricant from a surface of the solid block according to a pressing force of the pressing member and supplies the lubricant to the image carrier.

According to at least one embodiment, the operation prompted by the guidance is to restore the pressing force of the pressing member.

According to at least one embodiment, the operation to restore the pressing force of the pressing member is replacing the pressing member.

According to at least one embodiment, the hardware processor and the recording medium further cause the display to display information indicating a replacement pressing member that has a pressing force proportional to a remaining amount of the solid block as a replacement for the pressing member.

According to at least one embodiment, the solid block, the lubricant supplier, and the pressing member are housed inside a housing, a wall of the housing has a through hole for removing and replacing the pressing member, the through hole is covered by a removable cover, and the pressing member is sandwiched between the cover when mounted and the solid block.

According to at least one embodiment, the pressing member is an elastic body.

According to at least one embodiment, the elastic body is a compression spring.

According to at least one embodiment, the lubricant supplier is a rotating brush in which brush bristles protrude from a circumferential surface of a cylinder, and when the lubricant supplier rotates, the brush bristles scrape the lubricant from the surface of the solid block.

According to at least one embodiment, the hardware processor and the recording medium cause the display to display guidance prompting a change in rotation speed of the rotating brush when the parameter exceeds a threshold value.

According to at least one embodiment, the image carrier is rotatable, and the parameter is either a cumulative number of sheets printed by the image forming device, a cumulative number of rotations of the image carrier, or a cumulative usage time of the image carrier.

According to at least one embodiment, the image forming device includes an input receiver that receives input from a user, wherein if the input receiver has not received input indicating that a user has restored lubrication performance of the lubrication device for a defined time after the display of the guidance prompting restoration of lubrication performance of the lubrication device, the hardware processor and the recording medium control the lubrication device to supply more lubricant than would be supplied during image forming, in a standby time period in which the image forming device is waiting to receive an instruction to execute image forming.

According to at least one embodiment, the image carrier is rotatable, the lubricant supplier is a rotating brush in which brush bristles protrude from a circumferential surface of a cylinder, and in order to supply more lubricant than would be supplied during image forming in the standby time period, the hardware processor and the recording medium cause the image carrier to rotate at a circumferential speed slower than that used during image forming, and cause the rotating brush to rotate at a circumferential speed equal to that used during image forming.

According to at least one embodiment, the image forming device includes an input receiver that receives input from a user, wherein if the input receiver has not received input indicating that a user has restored lubrication performance of the lubrication device for a defined time after the display of the guidance prompting restoration of lubrication performance of the lubrication device, the hardware processor and the recording medium cause the display to display guidance prompting lubrication.

According to at least one embodiment, if the input receiver has not received input indicating that a user has executed lubrication for a defined time after the display of the guidance prompting lubrication, the hardware processor and the recording medium change image forming conditions.

According to at least one embodiment, the image carrier is rotatable, the lubricant supplier is a rotating brush in which brush bristles protrude from a circumferential surface of a cylinder, and if the input receiver has not received input indicating that a user has executed lubrication for a defined time after the display of the guidance prompting lubrication, the hardware processor and the recording medium cause the image carrier to rotate during image forming at a circumferential speed slower than that used during image forming before the change in image forming conditions, and cause the rotating brush to rotate during image forming at a circumferential equal to that used during image forming before the change in image forming conditions.

According to at least one embodiment, if the input receiver has not received input indicating that a user has executed lubrication for a defined time after the display of the guidance prompting lubrication, the hardware processor and the recording medium cause the display to display guidance prompting a change in image forming conditions.

According to at least one embodiment, the image forming device includes an input receiver that receives input from a user, wherein if the input receiver has not received input indicating that a user has restored lubrication performance of the lubrication device for a defined time after the display of the guidance prompting restoration of lubrication performance of the lubrication device, the hardware processor and the recording medium change image forming conditions.

According to at least one embodiment, the image forming device further includes an input receiver that receives input from a user, wherein if the input receiver has not received input indicating that a user has restored lubrication performance of the lubrication device for a defined time after the display of the guidance prompting restoration of lubrication performance of the lubrication device, the hardware processor and the recording medium cause the display to display guidance prompting a change in image forming conditions.

Further, according to an aspect of the present disclosure, a control method used in an image forming device that forms a toner image on an image carrier comprising a lubrication device that applies lubricant to the image carrier and a display, is a control method including acquiring a parameter that indicates lubrication performance of the lubrication device, comparing the parameter to a threshold value, and when the parameter exceeds the threshold value, displaying guidance on the display prompting an operation to restore lubrication performance of the lubrication device.

According to the aspects described above, even if lubrication performance of the lubrication device that lubricates the image carrier is reduced due to long-term use, it is possible to prevent deterioration of image quality of the next image to be formed.

### BRIEF DESCRIPTION OF DRAWINGS

The advantages and features provided by one or more embodiments of the disclosure will become more fully understood from the detailed description given hereinbelow and the appended drawings which are given by way of illustration only, and thus are not intended as a definition of the limits of the invention. In the drawings:

FIG. 1 is a diagram schematically illustrating an overall structure of an image forming device 1 according to an embodiment.

FIG. 2A is a diagram illustrating an enlargement of a lubrication device 200 in an image forming unit 41 of a print engine 13, and FIG. 2B is a diagram illustrating an enlargement of the lubrication device 200 in which a cover 207 is removed and a compression spring 203x protrudes.

FIG. 3 is a block diagram illustrating structure of control circuitry 14.

FIG. 4 is a graph illustrating lubrication performance before replacing a compression spring.

FIG. 5 is a graph illustrating lubrication performance after replacing a compression spring.

FIG. 6 illustrates a screen 301 displayed on an operation panel 20.

FIG. 7 is a flowchart illustrating operations of the image forming device 1.

FIG. 8A, 8B, 8C are diagrams illustrating states of the lubrication device 200 of Modification 1 in which the cover 207 is removed and compression springs 203a, 203b, 203c protrude.

FIG. 9 is a table 451 illustrating identification information of a compression spring to be used as a replacement according to an amount of protrusion of the compression spring.

FIG. 10 illustrates a screen 311 displayed on the operation panel 20.

FIG. 11 is a graph illustrating lubrication performance after replacing a compression spring.

FIG. 12 illustrates a screen 321 displayed on the operation panel 20 of Modification 2.

FIG. 13 illustrates a screen 331 displayed on the operation panel 20.

FIG. 14 illustrates a screen 341 displayed on the operation panel 20.

FIG. 15 is a flowchart illustrating generation and display of the screen 321 including a warning, according to Modification 2.

FIG. 16 is a flowchart illustrating forcibly executing a lubrication mode according to Modification 2.

FIG. 17 is a flowchart illustrating executing the lubrication mode after lubrication mode guidance is displayed according to Modification 2.

FIG. 18 is a flowchart illustrating changing an image forming condition when user consent is not obtained after a lubrication mode guidance is displayed, according to Modification 2.

FIG. 19 is a flowchart illustrating changing an image forming condition when user consent is obtained after lubrication mode guidance is displayed and image forming condition change guidance is displayed, according to Modification 2.

FIG. 20 is a flowchart illustrating forcibly changing an image forming condition according to Modification 2.

### DETAILED DESCRIPTION

### 1. Embodiments

The following describes at least one embodiment with reference to the drawings.

1.1. Image forming device 1

The image forming device 1 is a tandem-type color multifunction peripheral (MFP) that has functions such as scanning, printing, and copying.

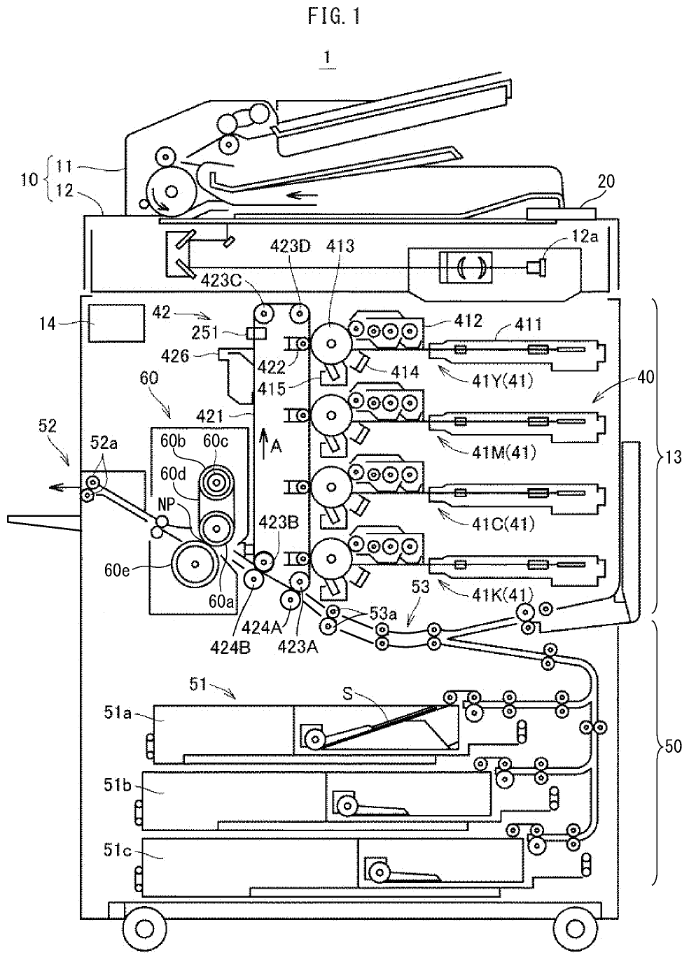

As illustrated in FIG. 1, the image forming device 1 includes a sheet conveyance unit 50 that accommodates and conveys sheets, located towards a bottom of a housing of the image forming device 1. Above the sheet conveyance unit 50 are a print engine 13 for forming an image by an electrophotographic method and control circuitry 14 for integrally controlling each function block of the image forming device 1. Above the print engine 13 and the control circuitry 14 are a scanner 10 for scanning documents to generate input image data and an operation panel 20 for displaying an operation screen and receiving input operations from a user.

(1) Scanner 10

The scanner 10 includes an automatic document feeder (ADF) 11, a document image scanning device 12, and the like.

The ADF 11 conveys a document placed on a document tray by a conveyance mechanism and sends it out to the document image scanning device 12.

The document image scanning device 12 optically scans a document either conveyed from the ADF 11 onto contact glass or placed on contact glass; such that light reflected from the document into a charge coupled device (CCD) sensor 12a forms an image on a light receiving surface of the sensor 12a to scan a document image. The scanner 10 generates input image data based on a scanning result by the document image scanning device 12.

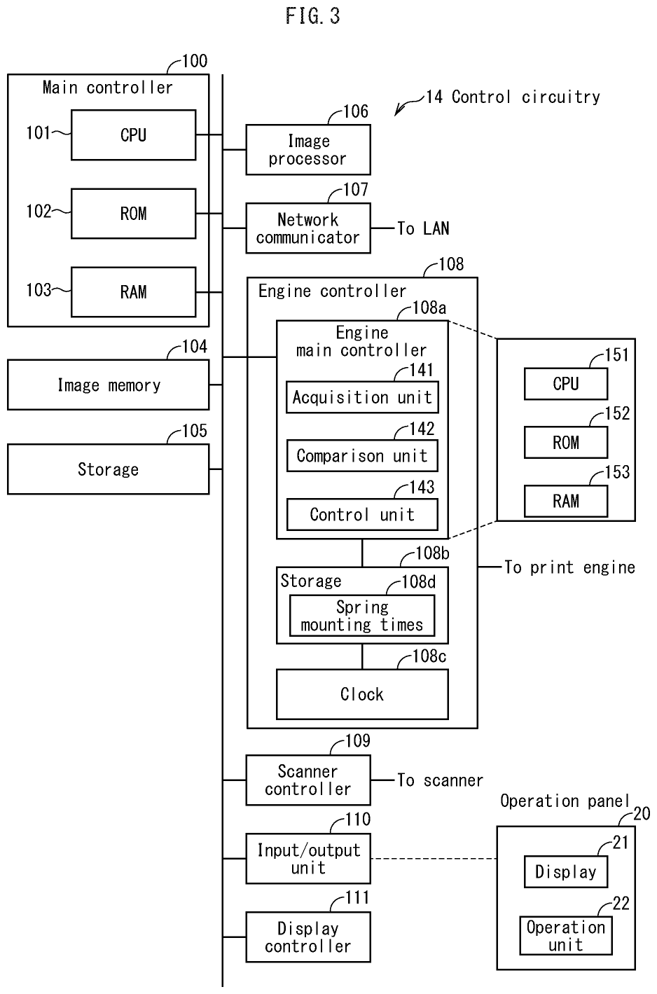

The scanner 10 writes generated input image data to an image memory 104 (FIG. 3).

(2) Print Engine 13

The print engine 13 includes an image former 40 that forms an image by electrophotography and a fixing device 60 that fuses a toner image to a sheet.

The image former 40 includes image forming units 41Y, 41M, 41C, 41K, an intermediate transfer unit 42, and the like, for forming an image from yellow (Y), magenta (M), cyan (C), and black (K) components of color toner, based on input image data stored in the image memory 104.

The image forming units 41Y, 41M, 41C, 41K have the same structure as each other. To simplify illustration and description, components in common are indicated by the same reference signs, and Y, M, C, or K may be added to a reference sign to distinguish color. In FIG. 1, reference signs are shown only for components of the image forming unit 41Y, and omitted for components of the image forming units 41M, 41C, 41K. The following describes the image forming unit 41Y as an image forming unit 41 representative of the image forming units 41Y, 41M, 41C, 41K.

The image forming unit 41 includes an exposure device 411, a developing device 412, a photosensitive drum 413, a charging device 414, a drum cleaning device 415, and the like.

The photosensitive drum 413 (image carrier) rotates at a constant circumferential speed due to the control circuitry 14 controlling a drive current supplied to a drive motor (not illustrated) that rotates the photosensitive drum 413. Rotation of the drive motor is controlled by drive current supplied from the control circuitry 14.

The charging device 414 uniformly charges a surface of the photosensitive drum 413 to a negative polarity.

The exposure device 411 includes a semiconductor laser, for example, and irradiates the photosensitive drum 413 with laser light corresponding to a color component of an image. Due to irradiation by the laser beam, an electrostatic latent image of the color component is formed on the surface of the photosensitive drum 413.

The developing device 412 is, for example, a two-component-developer type of developing device. The developing device 412 causes an electrostatic latent image to be visualized by transferring toner corresponding to the color component to the surface of the photosensitive drum 413 to form a toner image.

The drum cleaning device 415 includes a drum cleaning blade or the like that slides along the surface of the photosensitive drum 413 to remove residual toner remaining on the surface of the photosensitive drum 413 after transfer.

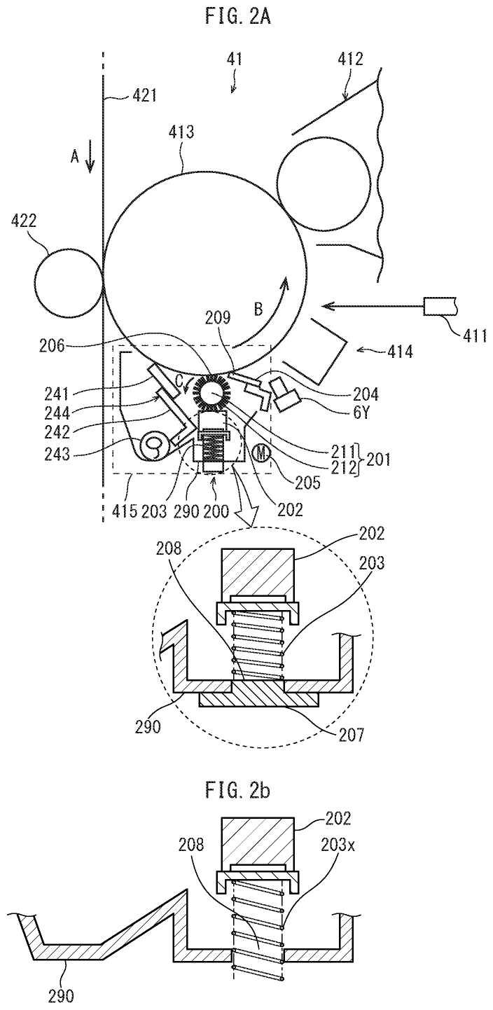

As illustrated in FIG. 2, a lubricant is applied by a lubrication device 200 to the circumferential surface of the photosensitive drum 413 from which residue such residual toner has been removed. Due to the rotation of the photosensitive drum 413, applied lubricant passes by positions of the charging device 414, the developing device 412, etc., along the circumferential direction until the lubricant reaches a cleaning unit 244 where the lubricant is supplied to a portion of a cleaning blade 241 in contact with the photosensitive drum 413.

Accordingly, friction between the cleaning blade 241 and the photosensitive drum 413 is reduced, and premature wear of the cleaning blade 241 is prevented, so that cleaning performance can be maintained over a long period of time. Further, suppressing wear on the circumferential surface of the photosensitive drum 413 can improve a lifespan of the photosensitive drum 413. Further, toner transfer performance can be maintained over a long period of time because a lubricant film is disposed between the circumferential surface of the photosensitive drum 413 and toner particles of a toner image developed on the circumferential surface of the photosensitive drum 413.

Details of the lubrication device 200 are provided later.

As illustrated in FIG. 1, the intermediate transfer unit 42 includes an intermediate transfer belt 421, primary transfer rollers 422, support rollers 423A, 423B, 423C, 423D, secondary transfer rollers 424A, 424B, a belt cleaning device 426, and the like.

The intermediate transfer belt 421 is an endless belt, held taught in a loop by the support rollers 423A, 423B, 423C, 423D. Among the support rollers 423A, 423B, 423C, 423D, the support roller 423A is a drive roller. Rotation of the support roller 423A causes the intermediate transfer belt 421 to move in a direction of arrow A at a constant speed.

The primary transfer rollers 422 of each color component are disposed on an inner circumferential side of the intermediate transfer belt 421 facing the photosensitive drums 413 of each color component. The primary transfer roller 422 is pressed against the photosensitive drum 413 with the intermediate transfer belt 421 therebetween, forming a primary transfer nip for transferring a toner image from the photosensitive drum 413 to the intermediate transfer belt 421.

When the intermediate transfer belt 421 passes through a primary transfer nip, a toner image of a corresponding color component on the photosensitive drum 413 is transferred to the intermediate transfer belt 421. Imaging timing of the image forming units 41Y, 41M, 41C, 41K is staggered such that Y, M, C, K toner images are superimposed on the intermediate transfer belt 421.

The secondary transfer rollers 424A, 424B are disposed on an outer circumferential side of the intermediate transfer belt 421, facing the support rollers 423A, 423B disposed on an inner circumferential side of the intermediate transfer belt 421. The secondary transfer rollers 424A, 424B are pressed against the support rollers 423A, 423B, respectively, with the intermediate transfer belt 421 therebetween, forming a secondary transfer nip for transferring a toner image from the intermediate transfer belt 421 to a sheet S.

As a sheet S passes through the secondary transfer nip, the toner image on the intermediate transfer belt 421 is transferred onto the sheet S. The sheet S with the toner image thereon is conveyed towards the fixing device 60.

The belt cleaning device 426 includes a belt cleaning blade or the like that slides on the surface of the intermediate transfer belt 421, removing residual toner on the surface of the intermediate transfer belt 421 after the transfer at the secondary transfer nip.

The fixing device 60 is downstream from the secondary transfer nip in a conveyance direction of the sheet S. The fixing device 60 includes a fixing roller 60a, a heating roller 60b that includes a fixing heater 60c as a heat source, and an endless fixing belt 60d around the fixing roller 60a and the heating roller 60b. A pressure roller 60e applies pressure to the fixing roller 60a via the fixing belt 60d, forming a fixing nip NP between the pressure roller 60e and the fixing belt 60d.

At the fixing nip NP, the fixing device 60 heats and applies pressure to the sheet S conveyed from the secondary transfer nip. After passing through the fixing nip NP, the sheet S is conveyed towards the sheet discharger 52.

(3) Sheet Conveyance Unit 50

The sheet conveyance unit 50 includes a sheet feeder 51, a conveyance path section 53, a sheet discharger 52, and the like. The sheet conveyance unit 50 is controlled according to instructions from the control circuitry 14.

The sheet feeder 51 is disposed towards the bottom of the housing of the image forming device 1, and the conveyance path section 53 is disposed downstream in a sheet conveyance direction from the sheet feeder 51.

The sheet feeder 51 includes three sheet feed tray units 51a, 51b, 51c. Sheets are stored in the sheet feed tray units 51a, 51b, 51c. The sheets S stored in the sheet feed tray units 51a, 51b, 51c, can be conveyed to the conveyance path section 53.

The conveyance path section 53 includes conveyance roller pairs such as a resist roller pair 53a. When a sheet S is conveyed from the sheet feeder 51 to the conveyance path section 53, the resist roller pair 53a corrects skew of the sheet S and adjusts conveyance timing. Subsequently, the sheet S is conveyed towards the secondary transfer nip.

The sheet discharger 52 includes a sheet discharge roller 52a. The sheet S conveyed from the fixing device 60 is discharged outside by the sheet discharge roller 52a.

(4) Drum Cleaning Device 415

FIG. 2A is a schematic cross-section diagram illustrating an enlargement of structure of the lubrication device 200 included in the drum cleaning device 415 of the image forming unit 41, in which other components such as the photosensitive drum 413 and the cleaning blade 241 are also shown.

As illustrated, the cleaning unit 244, the lubrication device 200, and a leveling blade 204 are arranged in this order around the photosensitive drum 413 along a rotation direction B of the photosensitive drum 413. The cleaning unit 244, the lubrication device 200, and the leveling blade 204 are supported so as to be detachable from a main body of the image forming device 1, and are housed in a housing 290 as one unit (the drum cleaning device 415).

(Cleaning Unit 244)

The cleaning blade 241 of the cleaning unit 244 is polyurethane rubber processed into a plate shape. The cleaning blade 241 is attached to a holding metal plate 242 with a hot melt adhesive. A tip of the cleaning blade 241 contacts the circumferential surface of the photosensitive drum 413 in a direction opposed to the rotation direction B (counter direction). The cleaning blade 241 scrapes off residue, including residual toner, on the photosensitive drum 413. Scraped off residue falls to a collection screw 243 in the housing 290, and is conveyed to a waste toner collection box (not illustrated) by the collection screw 243.

(Lubrication Device 200)

The lubrication device 200 includes a brush roller 201 (lubricant supplier), a solid lubricant 202, compression springs 203 (pressure members), a brush motor 205, and the like.

The brush roller 201, the solid lubricant 202, the leveling blade 204, the cleaning blade 241, and the housing 290 for accommodating them are all elongated along an axial direction of the photosensitive drum 413 (drum axial direction). Length in the axial direction is longer than a length of an image forming area of the photosensitive drum 413 in a main scanning direction (print width). The compression springs 203 are arranged at intervals along the axial direction.

A hole 208 (through hole) through a bottom side of the housing 290 is provided for the purpose of replacing the compression springs 203. The hole 208 is closed from below by a removable cover 207, and the cover 207 is attached to the housing 290 by a screw.

The cover 207 when screwed to the housing 290 supports the compression springs 203. When the cover 207 is removed from the housing 290, a compression spring 203x that has returned to its natural length protrudes downwards from the hole 208, as illustrated in FIG. 2B. With the cover 207 removed, the compression spring 203x can be taken out from the hole 208 and replaced. A new compression spring can be inserted into the housing 290 via the hole 208.

The brush roller 201 includes a metal core 211 made of an electrically conductive metal material, such as iron, and a brush 212 (also referred to as “brush fiber”) on a circumferential surface of the metal core 211 made of a large number of electrically conductive brush bristles. The brush roller 201 is disposed between the photosensitive drum 413 and the solid lubricant 202, and a portion of the brush fiber 212 facing the circumferential surface of the photosensitive drum 413 contacts the circumferential surface of the photosensitive drum 413 to apply (supply) lubricant to the circumferential surface of the photosensitive drum 413. A contact position between the brush roller 201 and the circumferential surface of the photosensitive drum 413 is a lubrication position 206 of lubricant to the photosensitive drum 413.

The metal core 211 rotates in a direction opposite the rotation direction B at the lubrication position 206 (rotation direction C indicated by arrow C), according to a drive force of a brush motor 205. During an image-forming operation, circumferential speed of brush hair tips of the brush fibers 212 in the rotation direction C of the metal core 211 is defined as a rotation speed of the brush roller 201, and is a multiple of a constant speed (circumferential speed) of the circumferential surface of the photosensitive drum 413, for example 0.5.

An example of the brush fiber 212 is a straight hair brush. A straight hair brush is made of electrically conductive acrylic, has an electrical resistance of 106Ω, a fiber thickness of 3 decitex, and a fiber density of 150 kilo filament (KF) per square inch, or in other words 150,000 fibers per square inch.

Diameter of the metal core 211 is 6 mm, and height of brush bristles of the straight hair brush of the brush fiber 212 is approximately 2.5 mm. The brush fiber 212 is woven on an electrically conductive base cloth (not illustrated) wound around the metal core 211. Thickness of the base cloth is approximately 0.5 mm. Diameter of the brush roller 201 is approximately 12 mm.

The solid lubricant 202 is melted and molded soap powder, made of a fatty acid metal salt. Here, zinc stearate that has a negative triboelectric charging property is used.

Zinc stearate is characterized by a high mold release property (corresponding to a high pure water contact angle) and small coefficient of friction, and has high transferability and cleaning properties, making it appropriate as a lubricant, but the solid lubricant 202 is not limited to being zinc stearate.

For example, metal stearate such as aluminum stearate, copper stearate, or magnesium stearate, metal oleate such as zinc oleate, manganese oleate, iron oleate, copper oleate, or magnesium oleate, metal palmitate such as zinc palmitate, copper palmitate, or magnesium palmitate, metal linoleate such as zinc linoleate, metal ricinoleate such as zinc ricinoleate or lithium ricinoleate, or the like may be used as lubricant.

Each of the compression springs 203 is an elastic body that applies a force to the solid lubricant 202 that presses the solid lubricant 202 against the brush roller 201. Lubricant on a surface of the solid lubricant 202 pressed against the brush roller 201 is scraped off by brush bristles of the brush fiber 212 as the brush roller 201 rotates. Scraped off lubricant is conveyed to the lubrication position 206 on the photosensitive drum 413 by rotation of the brush roller 201, where the lubricant is supplied to the photosensitive drum 413.

(Leveling Blade 204)

The leveling blade 204 is polyurethane rubber processed into a sheet shape. A tip 209 of the leveling blade 204 is in contact with the circumferential surface of the photosensitive drum 413 in a direction opposed to the drum rotation direction B (counter direction). Lubricant supplied to the photosensitive drum 413 passes through a gap that occurs between the tip 209 and the circumferential surface of the photosensitive drum 413. When passing through the gap, the lubricant on the photosensitive drum 413 is leveled on the circumferential surface of the photosensitive drum 413. As a result, a lubricant film having a uniform thickness is formed on the photosensitive drum 413.

(5) Control Circuitry 14

The control circuitry 14, as illustrated in FIG. 3, includes a main controller 100, the image memory 104, a storage 105, an image processor 106, a network communicator 107, an engine controller 108, a scanner controller 109, an input/output unit 110, a display controller 111, and the like.

(5-1) Main Controller 100

The main controller 100 includes a central processing unit (CPU) 101, a read-only memory (ROM) 102, a random-access memory (RAM) 103, and the like. In other words, the main controller 100 is a computer that includes a microprocessor and a non-transitory memory.

The RAM 103 includes a semiconductor memory, temporarily stores various control variables, and provides a work area when the CPU 101 executes a program.

The ROM 102 includes a semiconductor memory and stores at least a control program for executing various jobs such as a scan job, a copy job, and a print job. The control program is a computer program. The computer program is configured by combining instruction codes indicating instructions to the computer in order to achieve a defined function.

The CPU 101 is a microprocessor (hardware processor). The microprocessor includes a fetch unit, a decoding unit, an execution unit, a register file, an instruction counter, and the like. The fetch unit fetches each instruction code included in a computer program one by one from the computer program stored in memory. The decoding unit decodes each instruction code read. The execution unit executes instructions according to decoding results.

Thus, the CPU 101 operates according to a control program, which is a computer program, stored on the ROM 102, which is a non-transitory computer-readable recording medium.

As described above, when the CPU 101 operates according to the control program, the main control unit 100 integrally controls the image memory 104, the storage 105, the image processor 106, the network communicator 107, the engine controller 108, the scanner controller 109, the input/output unit 110, the display controller 111, and the like, according to a scan job, a copy job, a print job, or the like.

For example, when the main controller 100 receives a print job via the network communicator 107 due to operations according to the control program, the main controller 100 instructs the engine controller 108 to cause the print engine 13 to execute an image forming operation based on the print job.

(5-2) Image Memory 104 and Storage 105

The image memory 104 includes a semiconductor memory and temporarily stores input image data such as that of a print job.

The storage 105 includes a non-volatile semiconductor memory. Of course, the storage 105 may include a hard disk drive.

(5-3) Image Processor 106

The image processor 106 includes circuitry that executes digital image processing on input image data stored in the image memory 104. For example, the image processor 106 executes grey level correction based on grey level correction data (grey level correction table) under control of the control circuitry 14. Further, the image processor 106 executes various types of correction processing such as color correction and shading correction, as well as compression processing and the like on the input image data stored in the image memory 104. Further, the image processor 106 executes various types of data processing on input image data composed of red (R), green (G), and blue (B) multi-value digital signals that are included in a print job received from an external terminal device or generated from scanning by the scanner 10, in order to convert the input image data into Y, M, C, K color components. The print engine 13 is controlled based on the input image data subjected to this processing.

(5-4) Network Communicator 107 and Scanner Controller 109

The network communicator 107 receives a print job from an external terminal device via a network. Further, the network communicator 107 outputs messages and the like to an external terminal device as required.

The scanner controller 109 controls scanning of a document by the scanner 10. For example, the scanner controller 109 specifies resolution when the scanner 10 scans a document. The scanner controller 109 writes image data received from the scanner 10 to the image memory 104.

(5-5) Engine Controller 108

The engine controller 108, as illustrated in FIG. 3, includes an engine main controller 108a, a storage 108b, and a clock 108c. Even when power of the image forming device 1 is off, power is always supplied to the storage 108b and the clock 108c from a built-in secondary battery (not illustrated).

(Storage 108b)

The storage 108b includes a non-volatile semiconductor memory that includes an area for storing a number of spring mounting times 108d equal to the number of the compression springs 203, in one-to-one correspondence. Each of the spring mounting times 108d indicates an elapsed time (cumulative time) from when a corresponding one of the compression springs 203 was mounted to the lubrication device 200 to the present. When one of the compression springs 203 is replaced, the corresponding one of the spring mounting times 108d is reset and returned to an initial value of “0 seconds”.

(Clock 108c)

The clock 108c measures time elapsed. The clock 108c adds measured elapsed time to the spring mounting times 108d stored in the storage 108b. More specifically, the clock 108c adds 1 second to each of the spring mounting times 108d for each second elapsed.

Power is always supplied to the storage 108b and the clock 108c, and therefore even when power to the image forming device 1 is off, time is always added to the spring mounting times 108d.

(Engine Main Controller 108a)

The engine main controller 108a includes a CPU 151 (hardware processor), a ROM 152 (non-transitory computer-readable recording medium), and a RAM 153. The RAM 153 is a semiconductor memory that temporarily stores various control variables and provides a work area when the CPU 151 executes a program. The ROM 152 includes a semiconductor memory, and stores a control program and the like for operating the engine controller 108. The CPU 151 operates according to the control program stored in the ROM 152.

The engine main controller 108a functions at least as an acquisition unit 141, a comparison unit 142, and a control unit 143 according to operations executed by the CPU 151 according to a control program stored in the ROM 152.

A hardware processor and a non-transitory computer-readable recording medium comprising computer-executable instructions that when executed by the hardware processor are configured to cause the image forming device 1 to: acquire a parameter that indicates lubrication performance of the lubrication device 200; compare the parameter to a threshold value; and when the parameter exceeds the threshold value, display guidance on the display prompting an operation to restore lubrication performance of the lubrication device 200.

The controller 143 integrally controls a sheet feeding operation from the sheet conveyance unit 50, each image forming operation of an image forming unit for each color component of the print engine 13, and the like, and causes execution of an image forming operation.

Further, the acquisition unit 141 reads the spring mounting times 108d from the storage 108b. The comparison unit 142 compares the spring mounting times 108d to a threshold value. Here, the threshold value indicates a time at which the compression springs 203 mounted on the lubrication device 200 should be replaced. The threshold value is, for example, 50% of a lifetime of an image forming unit. The threshold value is stored in advance in the storage 108b.

The comparison of the spring mounting times 108d to the threshold value is performed for each of the spring mounting times 108d stored in the storage 108b.

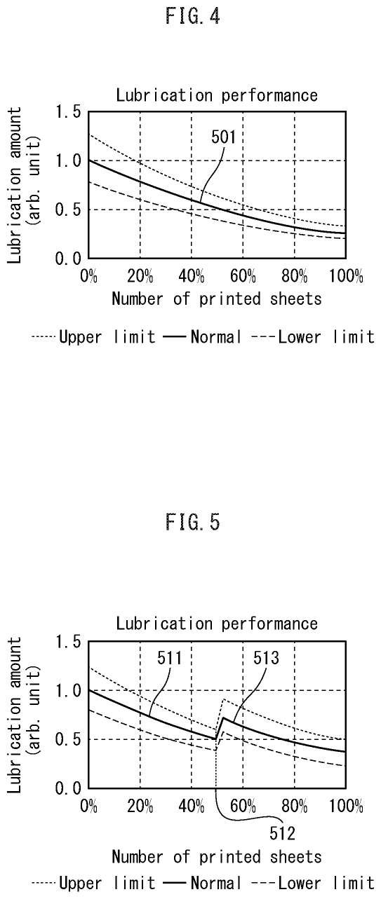

FIG. 4 is a graph illustrating lubrication performance by the lubrication device 200. In FIG. 4, the horizontal axis indicates a ratio (%) of a number of printed sheets to a lifetime number of printed sheets for each image forming unit of the image forming device 1, and the vertical axis indicates an amount of lubricant applied by the lubrication device 200. As illustrated, a lubrication amount 501 decreases as number of printed sheets increases. In FIG. 4, the passage of time can replace the number of printed sheets, and the decrease in the lubrication amount 501 can be considered to depend on deterioration of compression springs.

In other words, it can be considered that when the spring mounting times 108d become greater than the threshold value, the corresponding compression springs have deteriorated, and that lubrication performance by the lubrication device 200 decreases when deteriorated compression springs are used continuously.

Thus, when the spring mounting times 108d become larger than the threshold value, deteriorated compression springs are to be replaced with new compression springs so that lubrication performance by the lubrication device 200 can be restored.

According to the description above, the decrease in lubrication amount depends on deterioration of compression springs. However, the decrease in lubrication amount is not only caused by deterioration of compression springs, but also by the scraping away of a surface layer of the solid lubricant as lubricant is supplied. As a result, the solid lubricant becomes smaller, and a distance from the compression springs to the solid lubricant is increased, thereby weakening the force applied by the compression springs and reducing the lubrication amount. In this case, the reduction in lubrication amount can be compensated for by replacing the compression springs with longer (stronger) compression springs.

Here, the spring mounting times 108d are a parameter that indicates lubrication performance of the lubrication device 200.

FIG. 5 is a graph illustrating lubrication performance of the lubrication device 200 when deteriorated compression springs are replaced with new compression springs. In FIG. 5, the horizontal axis indicates a ratio of the number of printed sheets and the vertical axis indicates lubrication amount, as in FIG. 4. As illustrated, a lubrication amount 511 decreases as number of printed sheets increases. When the compression springs are replaced with new compression springs at a number of printed sheets 512, a lubrication amount 513 is restored. Further, even after replacement with new compression springs, deterioration of the new compression springs progresses as time passes, and the lubrication amount 513 gradually decreases.

Returning to FIG. 3, as described above, the comparison unit 142 compares the spring mounting times 108d to the threshold value. When the spring mounting times 108d exceed the threshold value, the controller 143 instructs the display controller 111 to cause display of guidance for replacing the compression springs of the lubrication device 200.

The controller 143 receives notification of replacement of compression springs (notification that compression springs have been replaced by a service person) from the operation panel 20 via the input/output unit 110. Upon receiving the notification of replacement of compression springs, the controller 143 resets the spring mounting times 108d stored in the storage 108b that correspond to the notification, resetting to an initial value of “0 seconds”. Subsequently, the controller 143 instructs the display controller 111 to delete the guidance for replacing the compression springs of the lubrication device 200.

(5-6) Input/Output Unit 110 and Display Controller 111

The input/output unit 110 relays data between the operation panel 20 and the display controller 111 and the like.

For example, the input/output unit 110 receives menu screens, images, messages, and the like from the display controller 111 and the like, and outputs to the operation panel 20.

Further, the input/output unit 110 receives job execution instructions and execution conditions for the image forming device 1 from the operation panel 20, and outputs to the network communicator 107, the engine controller 108, the scanner controller 109, and the like, via the main controller 100. As a result, the image forming device 1 executes a job received from the operation panel 20.

Further, the input/output unit 110 receives notification of replacement of compression springs from the operation panel 20. Upon receiving notification of replacement of compression springs, the input/output unit 110 outputs a notification of replacement of compression springs to the engine main controller 108a.

The display controller 111 controls changes of screens to be displayed by the operation panel 20. Further, the display controller 111 generates a screen to be displayed by the operation panel 20, and outputs the generated screen to the operation panel 20 via the input/output unit 110.

The display controller 111 receives from the engine main controller 108a an instruction to display guidance for replacing compression springs of the lubrication device 200. Further, the display controller 111 receives from the engine main controller 108a an instruction to delete guidance for replacing compression springs of the lubrication device 200. According to instructions from the engine main controller 108a, the display controller 111 generates a screen including guidance for replacing compression springs or generates a screen not including guidance for replacing compression springs.

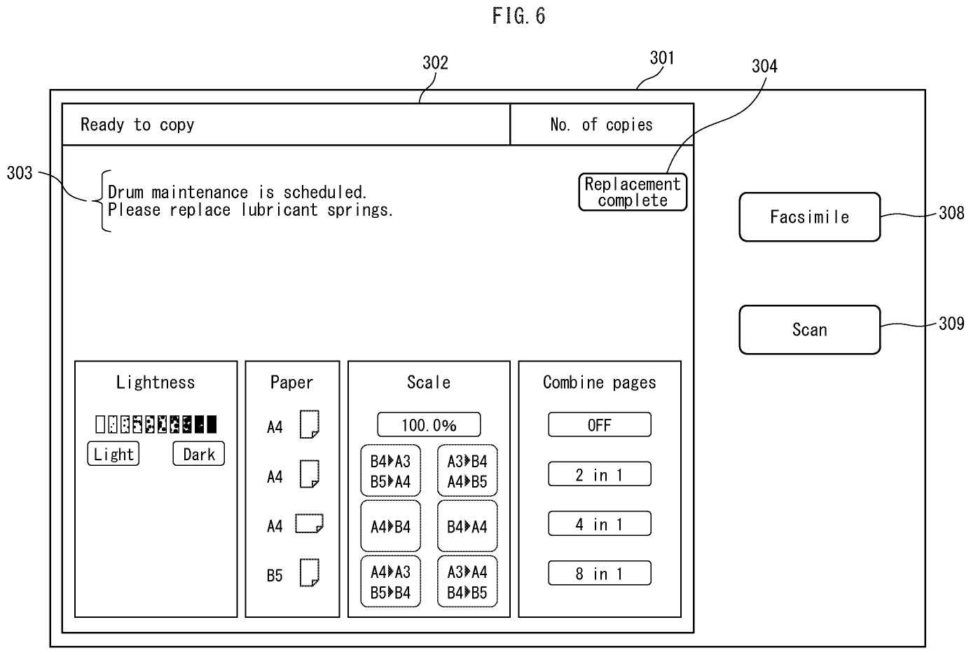

An example of a screen generated by the display controller 111 is illustrated in FIG. 6.

(Screen 301)

FIG. 6 illustrates screen 301, which is a screen including a message prompting a user to replace one or more compression springs of the lubrication device 200 and for setting conditions for executing a copy job.

The screen 301 includes a message frame 302 and buttons 308, 309.

The message frame 302 includes a message 303, a button 304, and various buttons for setting copy job conditions.

The message 303 is information prompting a user to replace one or more compression springs.

The message 303 may be displayed with respect to each of the compression springs.

The button 304 is an icon (instruction image) for a service person having replaced compression springs to notify the image forming device 1 that replacement of the compression springs has been completed. When the button 304 is operated, the controller 143 resets spring mounting times 108d stored in the storage 108b that correspond to the compression springs replaced, returning the corresponding spring mounting times 108d to an initial value of “0 seconds”.

The button 308 is an icon for a user to instruct the image forming device 1 to change to a screen for executing a facsimile transmission. The button 309 is an icon for a user to instruct the image forming device 1 to change to a screen for executing a scan. When the buttons 308, 309 are operated, the screen changes to a screen for executing facsimile transmission or a screen for executing scanning, respectively.

Thus, the screen 301 includes guidance prompting restoration of a pressing force of the compression springs 203 on the brush roller 201.

After compression spring replacement, a screen is displayed in which the message 303 and the button 304 are deleted from the screen 301 as illustrated in FIG. 6.

(6) Operation Panel 20

The operation panel 20 includes a display 21 and an operation unit 22 (FIG. 3).

The display 21 displays various operation screens, operation status of various functions, and the like, according to display control signals and screens output from the display controller 111. The display 21 displays, for example, the screen 301 illustrated in FIG. 6.

The operation unit 22 includes a touch panel and various operation keys such as a numeric keypad and a start key for receiving touch operations from a user. Upon receiving a touch operation, the operation unit 22 outputs an operation signal to the control circuitry 14. The operation panel 20 includes, for example, a liquid crystal display (LCD) with a touch panel.

### 1.2. Image Forming Device 1 Operations

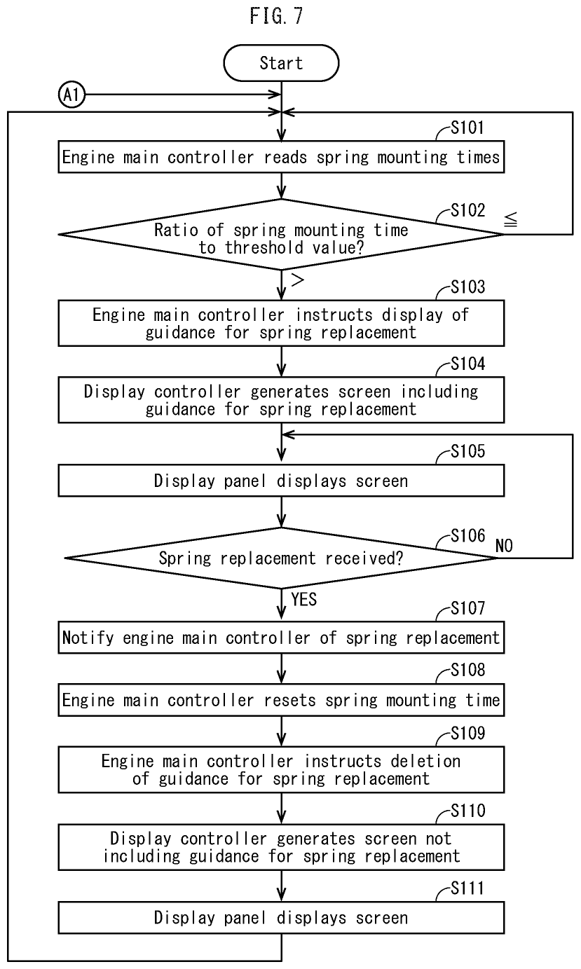

Operations of the image forming device 1 are described with reference to the flowchart illustrated in FIG. 7. The following operations are performed with respect to each of the compression springs 203.

The acquisition unit 141 acquires the spring mounting times 108d by reading the spring mounting times 108d from the storage 108b (step S101). Next, the comparison unit 142 compares the spring mounting times 108d to the threshold value (step S102).

If the spring mounting times 108d do not exceed the threshold value (“<” in step S102), the controller 143 executes a control to return processing to step S101 and repeat.

If one or more of the spring mounting times 108d exceed the threshold value (“>” in step S102), the controller 143 instructs the display controller 111 to display guidance for replacing a compression spring of the lubrication device 200 (step S103). The display controller 111 generates a screen including guidance for replacing a compression spring (step S104). The operation panel 20 displays the screen generated (step S105).

If the operation panel 20 does not receive operation of the button 304 for a defined time, for example 24 hours (“NO” in step S106), processing returns to step S105 and the operation panel 20 displays the screen.

If the operation panel 20 receives operation of the button 304 (“YES” in step S106), the operation panel 20 notifies the controller 143 of replacement of the compression spring (step S107). The controller 143 resets the corresponding one of the spring mounting times 108d stored in the storage 108b (step S108). Subsequently, the controller 143 instructs the display controller 111 to delete the guidance for replacing the compression spring of the lubrication device 200 (step S109). The display controller 111 generates a screen that does not include guidance for replacing the compression spring of the lubrication device 200 (step S110), and the operation panel 20 displays the screen that does not include guidance for replacing the compression spring (step S111). Subsequently, processing returns to step S101 and repeats.

### 1.3. Review

As described above, if the spring mounting times 108d exceed the threshold value, guidance is displayed for replacing compression springs of the lubrication device 200. If the guidance is followed and compression springs of the lubrication device 200 are replaced, lubrication performance of the lubrication device 200 can be restored.

Replacement of compression springs is performed by a service person upon a request by a user of the image forming device 1.

### 2. Modification 1

The following describes Modification 1 of an embodiment.

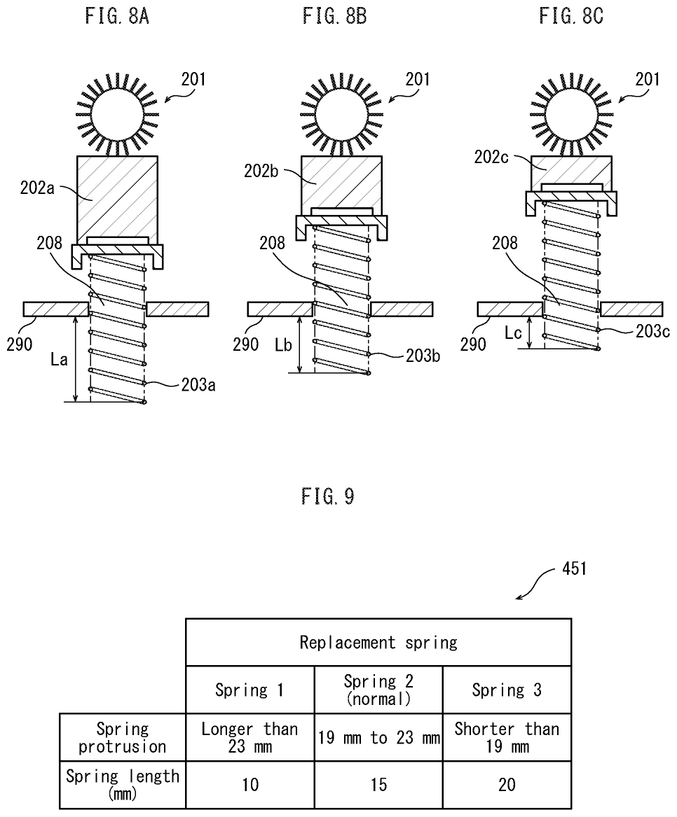

FIG. 8A, 8B, 8C illustrates states in which compression springs protrude downwards from the hole 208 when the cover 207 is removed from the housing 290.

FIG. 8B illustrates a case in which consumption of a solid lubricant 202b is normal according to the number of printed sheets. In this case, remaining amount of the solid lubricant 202b and protrusion Lb of a compression spring 203b are normal values. In contrast, FIG. 8A illustrates a case in which consumption of a solid lubricant 202a is small. In this case, remaining amount of the solid lubricant 202a and protrusion La of a compression spring 203a are larger than in the case illustrated in FIG. 8B. On the other hand, FIG. 8C illustrates a case in which consumption of a solid lubricant 202c is large. In this case, remaining amount of the solid lubricant 202c and protrusion Lc of a compression spring 203c are smaller than in the case illustrated in FIG. 8B.

FIG. 8A, 8B, 8C each illustrate a case in which, for example, the number of printed sheets reaches 50% of the lifetime number of printed sheets of the image forming unit. As described above, in each case, it may be assumed that consumption of solid lubricant varies depending on a unique situation of each image forming unit, for example depending on a unique elastic coefficient of compression springs and the like.

FIG. 9 is a table 451 illustrating identification information of a compression spring to be used as a replacement according to an amount of protrusion of the compression spring illustrated in FIG. 8A, 8B, 8C. That is, the table 451 links a protrusion amount of a compression spring as illustrated in FIG. 8A, 8B, 8C with identification information indicating a compression spring to be used as a replacement.

More specifically, the table 451, when a protrusion amount of a compression spring is large, for example more than 23 mm, indicates that a “spring 1” (a spring identifier for identifying a compression spring) with a spring length (natural length) of “10 mm” should be selected. Further, the table 451, when a protrusion amount of a compression spring is normal, for example from 19 mm to 23 mm, indicates that a “spring 2” with a spring length of “15 mm” should be selected. Further, the table 451, when a protrusion amount of a compression spring is small, for example less than 19 mm, indicates that a “spring 3” with a spring length of “20 mm” should be selected.

As described above, the table 451 includes identification information indicating a compression spring having a pressing property (elastic coefficient) that corresponds to a remaining amount of solid lubricant as the compression spring to be selected as a replacement.

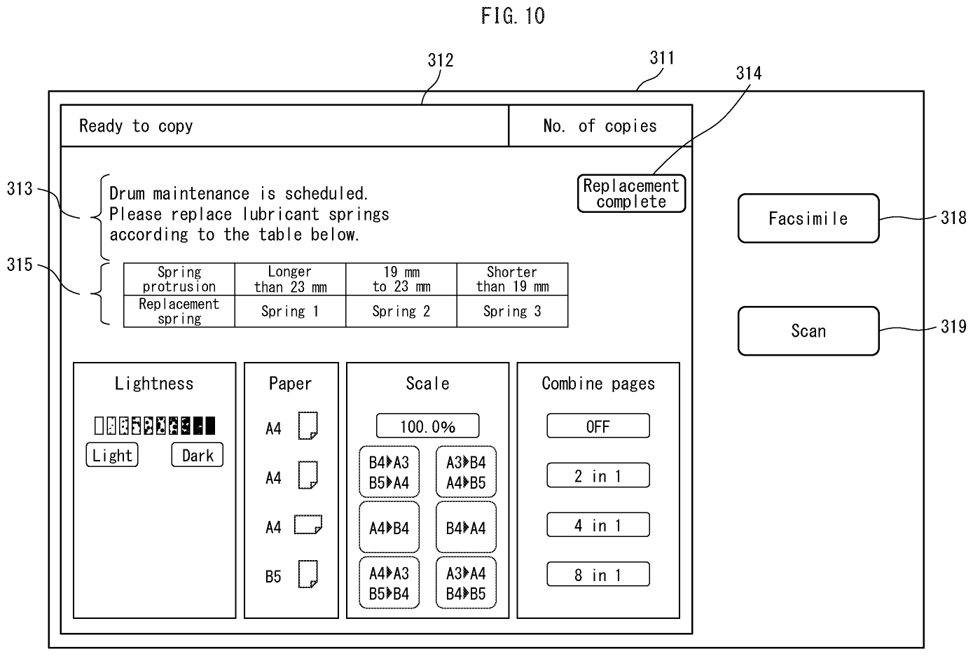

The display controller 111 generates a screen 311 as illustrated in FIG. 10 to replace the screen 301 as illustrated in FIG. 6, and causes the operation panel 20 to display the screen 311.

The screen 311 includes a message frame 312 and buttons 318, 319. The message frame 312 includes a message 313, a button 314, a table 315, copy job condition setting buttons, and the like.

The message 313 is information prompting a user to replace one or more compression springs.

The button 314, similar to the button 304 illustrated in FIG. 6, is an icon for a service person to notify the image forming device 1 that replacement of compression springs has been completed.

The table 315 includes compression spring protrusion amounts as illustrated in table 451, and corresponding identification information indicating compression springs to be used as a replacement. The table 315 may display information for individual compression springs.

The buttons 318, 319 are similar to the buttons 308, 309 illustrated in FIG. 6, and are icons for a user to instruct the image forming device 1 to change to a screen for executing a facsimile transmission and for a user to instruct the image forming device 1 to change to a screen for executing a scan, respectively.

Thus, the screen 311 includes guidance prompting restoration of a pressing force of the compression springs 203 on the brush roller 201. Further, the screen 311 includes identification information indicating a pressing member that has a pressing property according to a remaining amount of solid lubricant as the pressing member to be selected as a replacement.

After replacement of compression springs, a screen is displayed in which the message 313, the button 314, and the table 315 are deleted from the screen 311.

In response to display of the screen 311, a service person may remove the cover 207 from the housing 290 and measure compression spring protrusion downwards from the hole 208, as illustrated in FIG. 8A, 8B, 8C. Next, a service person may select a compression spring corresponding to protrusion measured, according to the table 315 of the screen 311. The service person may remove a compression spring protruding downwards from the hole 208, and replace the removed compression spring with a compression spring selected according to the table 315.

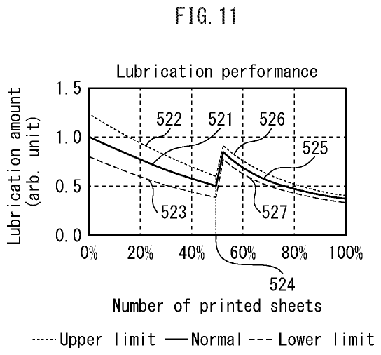

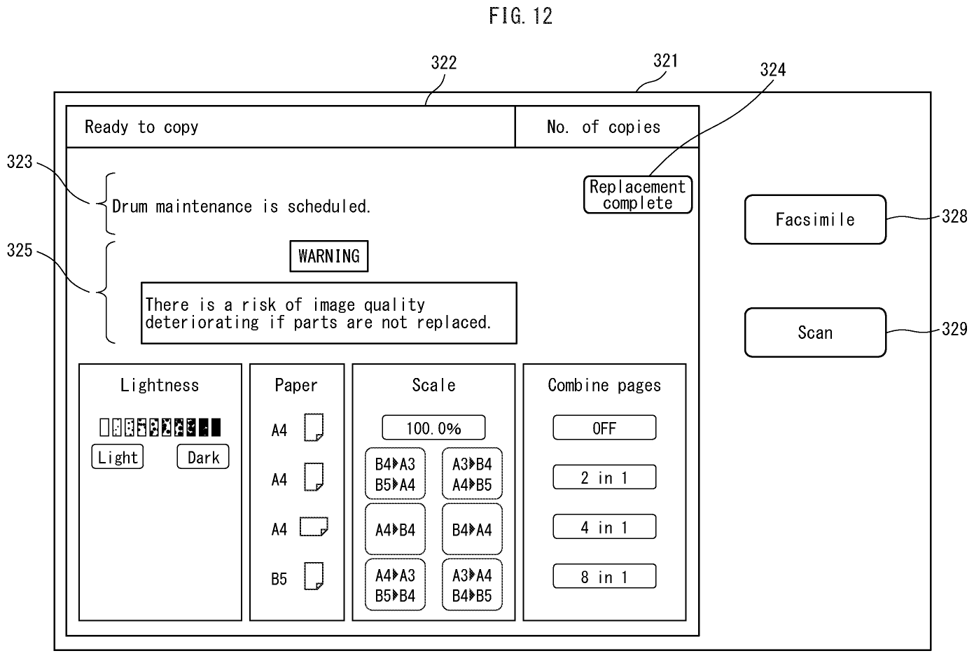

FIG. 11 is a graph illustrating lubrication performance of the lubrication device 200 when deteriorated compression springs are replaced with new compression springs. In FIG. 11, the horizontal axis indicates a ratio of the number of printed sheets and the vertical axis indicates lubrication amount, as in FIG. 4. As illustrated, lubrication amounts 521, 522, 523 decrease as number of printed sheets increases. When deteriorated compression springs are replaced with new compression springs at a number of printed sheets 524, the lubrication amounts 525, 526, 527 are restored. Further, even after replacement with new compression springs, deterioration of the new compression springs progresses as time passes, and the lubrication amounts gradually decrease.

Here, the lubrication amounts 521, 522, 523 vary as described above, depending on specific situations of each of the image forming units, for example specific elastic coefficients of compression springs. However, after replacement of compression springs, as indicated by the lubrication amounts 525, 526, 527, variation in lubrication amounts is small. This is because compression springs have been replaced with appropriate compression springs selected according to compression spring protrusion amounts and the table 315 shown in the screen 311.

As described above, variation in lubrication amounts after replacement is reduced, as illustrated in FIG. 11, and problems caused by excessive lubrication after replacement can also be prevented, by selecting and replacing compression springs according to compression spring replacement guidance shown on the screen 311.

### 3. Modification 2

The following describes Modification 2 of an embodiment, in which execution of a lubrication mode and changing of an image forming condition and the like are made in response to a user not following guidance for replacing compression springs.

(1) Execution of Lubrication Mode

When a user does not follow guidance for replacing compression springs, the image forming device 1 may forcibly execute a lubrication mode described below. Further, when a user does not follow guidance for replacing compression springs, the image forming device 1 may execute the lubrication mode after the operation panel 20 displays guidance for the lubrication mode.

In the lubrication mode, while the image forming device 1 is not executing image forming, that is, while the image forming device 1 is waiting for an image forming job, a control by the controller 143 causes the photosensitive drum 413 and lubrication device 200 of each image forming unit to be driven for one minute, for example.

In this case, under the control of the controller 143, the brush roller 201 rotates at the same circumferential speed as when executing image forming, but the photosensitive drum 413 rotates at a circumferential speed ½ that of rotation when executing image forming, for example. Thus, a lubricant film of appropriate thickness can be formed on the circumferential surface of the photosensitive drum 413.

Alternatively, under the control of the controller 143, the photosensitive drum 413 rotates at the same circumferential speed as when executing image forming, and the brush roller rotates at twice the circumferential speed as when executing image forming, for example. This can also form a lubricant film of appropriate thickness on the circumferential surface of the photosensitive drum 413.

When execution of the lubrication mode for one minute is complete, the image forming device 1 returns to waiting for execution of an image forming job.

In this way, rotation speed of the brush roller 201 may be changed to an appropriate speed in relation to circumferential speed of the photosensitive drum 413, in order that a lubricant film of appropriate thickness can be formed on the circumferential surface of the photosensitive drum 413.

Further, the operation panel 20 may display guidance prompting a user to change rotation speed of the brush roller 201.

(2) Changing Image Forming Conditions

When a user does not follow guidance for replacing compression springs, the image forming device 1 may forcibly change image forming conditions as described below. Further, when a user does not follow guidance for replacing compression springs, the image forming device 1 may change image forming conditions after the operation panel 20 displays guidance for changing image forming conditions.

Changing the image forming conditions means that when the image forming device 1 executes image forming, the controller 143 controls a system speed of the print engine 13 and the sheet conveyance unit 50 to be, for example, ½ normal system speed. In this case, the photosensitive drum 413 rotates at a circumferential speed half that of normal. Meanwhile, only the brush roller 201 of the lubrication device 200 of each of the image forming units rotates at a normal circumferential speed. Under these changed image forming conditions, image forming is executed for at least one minute, for example. As a result, an effect is achieved that is similar to executing the lubrication mode.

When execution of image forming under the changed image forming conditions for one minute is complete, the image forming device 1 returns image forming conditions to the settings before the change, and can continue to execute image forming.

(3) Examples of Screens Displayed by Operation Panel 20

The display controller 111 may generate screens 321, 331, 341, illustrated in FIG. 12, 13, 14, respectively, and the operation panel 20 may display the screens 321, 331, 341.

Here, each of the screens 321, 331, 341 includes guidance prompting restoration of pressing force applied to the brush roller 201 by the compression springs 203.

(Screen 321)

After the display controller 111 generates the screen 301 illustrated in FIG. 6 and the operation panel 20 displays the screen 301, when the button 304 indicating replacement completion has not been operated for a defined time, for example 24 hours, the display controller 111 may generate the screen 321 illustrated in FIG. 12 and the operation panel 20 may display the screen 321.

The screen 321 prompts a user to replace one or more compression springs and includes a warning message indicating that image quality may deteriorate if compression springs are not replaced, and is also a screen for setting conditions for executing a copy job.

The screen 321 includes a message frame 322 and buttons 328, 329. The message frame 322 includes a message 323, a button 324, a table 325, copy job condition setting buttons, and the like.

The message 323 is information prompting a user to replace one or more compression springs.

Like the button 304 of the screen 301, the button 324 is an icon for a service person who has replaced compression springs to notify the image forming device 1 that the replacement of compression springs has been completed.

The message 325 is a warning indicating that image quality may deteriorate when compression springs are not replaced.

Like the buttons 308, 309 of the screen 301, the buttons 328, 329 are icons for a user to instruct the image forming device 1 to change to a screen for executing a facsimile transmission and for a user to instruct the image forming device 1 to change to a screen for executing a scan, respectively.

After replacement of compression springs, a screen is displayed in which the message 323, the button 324, and the message 325 are deleted from the screen 321.

(Screen 331)

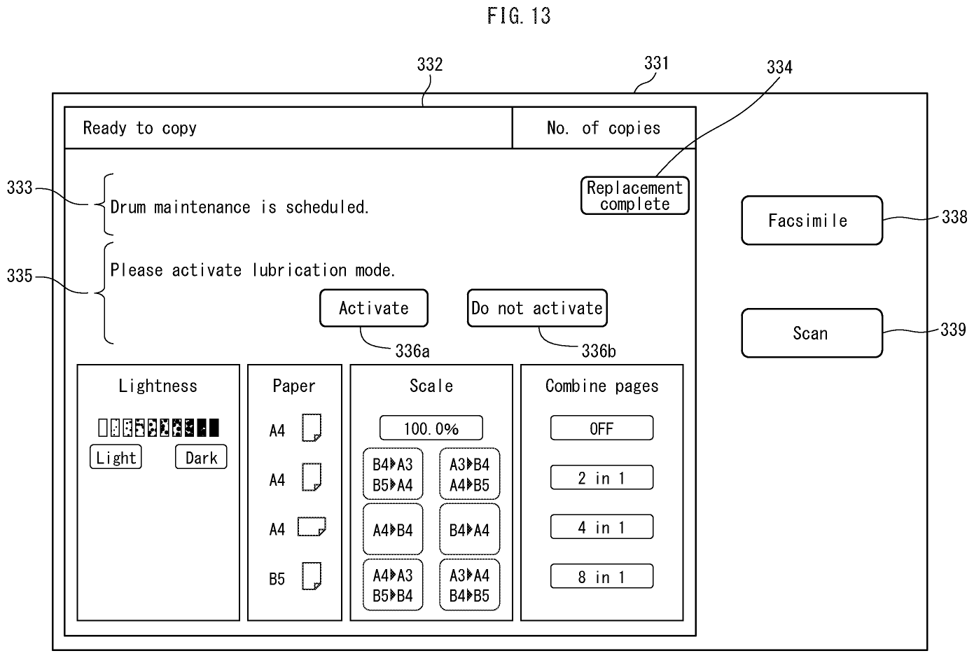

After the display controller 111 generates the screen 301 illustrated in FIG. 6 and the operation panel 20 displays the screen 301, when the button 304 indicating replacement completion has not been operated for a defined time, for example 24 hours, the display controller 111 may generate the screen 331 illustrated in FIG. 13 and the operation panel 20 may display the screen 331.

The screen 331 prompts a user to replace one or more compression springs and includes a message prompting execution of the lubrication mode if compression springs are not replaced, and is also a screen for setting conditions for executing a copy job.

The screen 331 includes a message frame 332 and buttons 338, 339. The message frame 332 includes a message 333, a button 334, a message 335, a button 336a, a button 336b, copy job condition setting buttons, and the like.

The message 333 is information prompting a user to replace one or more compression springs.

Like the button 304 of the screen 301, the button 334 is an icon for a service person who has replaced compression springs to notify the image forming device 1 that the replacement of compression springs has been completed.

The message 335 prompts execution of the lubrication mode.

The button 336a is an icon for a service person to instruct the image forming device 1 to execute the lubrication mode.

The button 336b is an icon for a service person to instruct the image forming device 1 not to execute the lubrication mode.

Like the buttons 308, 309 of the screen 301, the buttons 338, 339 are icons for a user to instruct the image forming device 1 to change to a screen for executing a facsimile transmission and for a user to instruct the image forming device 1 to change to a screen for executing a scan, respectively.

After compression springs are replaced, a screen in which the message 333, the button 334, the message 335, the button 336a, and the button 336b are deleted from the screen 331 is displayed. Further, after the lubrication mode is executed, a screen in which the message 335, the button 336a, and the button 336b are deleted from the screen 331 is displayed.

Further, the screen 331 need not include the button 336b. In this case, if operation of the button 336a is not received after a defined period of time has elapsed, the engine controller 108a may determine that operation of the button 336a will not occur.

(Screen 341)

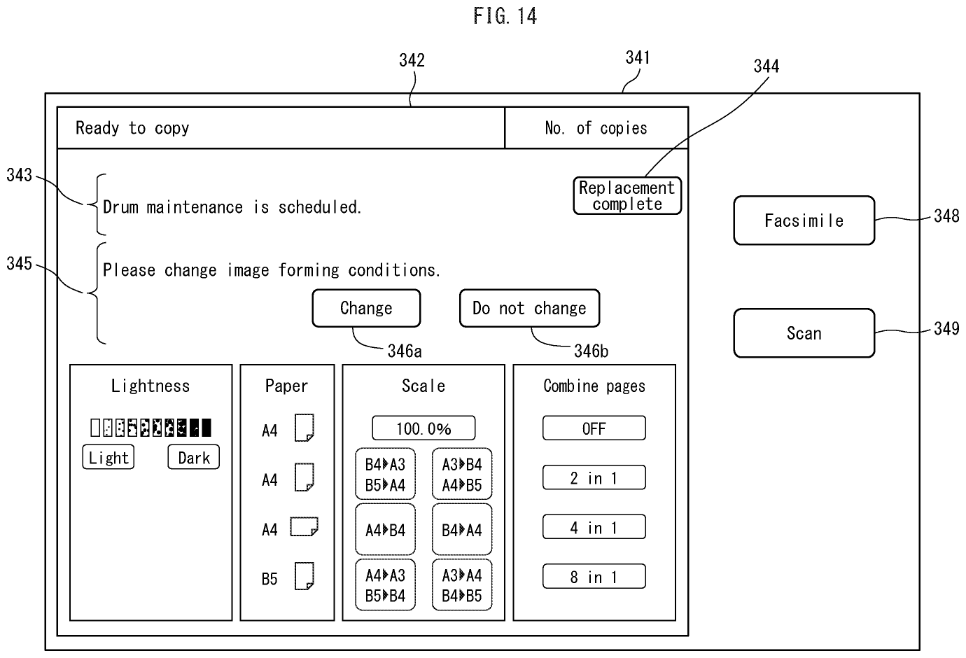

After the display controller 111 generates the screen 301 illustrated in FIG. 6 and the operation panel 20 displays the screen 301, when the button 304 indicating replacement completion has not been operated for a defined time, for example 24 hours, the display controller 111 may generate the screen 341 illustrated in FIG. 14 and the operation panel 20 may display the screen 341.

The screen 341 prompts a user to replace one or more compression springs and includes a message prompting a change in image forming conditions if compression springs are not replaced, and is also a screen for setting conditions for executing a copy job.

The screen 341 includes a message frame 342 and buttons 348, 349. The message frame 342 includes a message 343, a button 344, a message 345, a button 346a, a button 346b, copy job condition setting buttons, and the like.

The message 343 is information prompting a user to replace one or more compression springs.

Like the button 304 of the screen 301, the button 344 is an icon for a service person who has replaced compression springs to notify the image forming device 1 that the replacement of compression springs has been completed.

The message 345 prompts a change in image forming conditions.

The button 346a is an icon for a service person to instruct the image forming device 1 to change image forming conditions.

The button 346b is an icon for a service person to instruct the image forming device 1 to not change image forming conditions.

Like the buttons 308, 309 of the screen 301, the buttons 348, 349 are icons for a user to instruct the image forming device 1 to change to a screen for executing a facsimile transmission and for a user to instruct the image forming device 1 to change to a screen for executing a scan, respectively.

After compression springs are replaced, a screen in which the message 343, the button 344, the message 345, the button 346a, and the button 346b are deleted from the screen 341 is displayed. Further, after the lubrication mode is executed, a screen in which the message 345, the button 346a, and the button 346b are deleted from the screen 341 is displayed.

Further, the screen 341 need not include the button 346b. In this case, if operation of the button 346a is not received after a defined period of time has elapsed, the engine controller 108a may determine that operation of the button 346a will not occur.

(4) Image Forming Device 1 Operations of Modification 2

Operations of the image forming device 1 of Modification 2 are described with reference to a flowchart.

(4-1) Generation and Display of Screen Including Warning

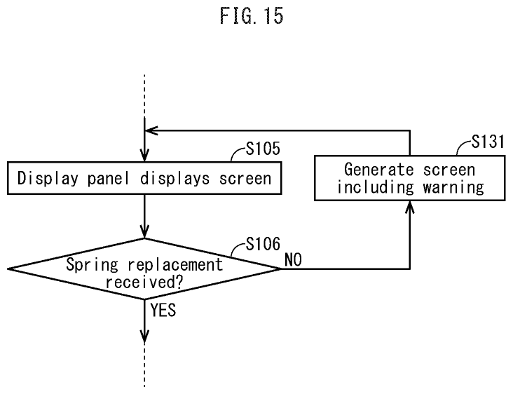

The following describes operations of the image forming device 1 using the flowchart illustrated in FIG. 15 as a reference, for a situation in which, after the display controller 111 generates the screen 301 illustrated in FIG. 6 and the operation panel 20 displays the screen 301 and the button 304 indicating replacement completion is not operated for a defined time, for example 24 hours, the display controller 111 generates the screen 321 illustrated in FIG. 12 and the operation panel 20 displays the screen 321. Here, description is provided focusing on differences from the flowchart illustrated in FIG. 7.

In step S106 of the flowchart illustrated in FIG. 7, when the operation panel 20 does not receive operation of the button 304 indicating compression spring replacement for a defined time (“NO” in step S106), the display controller 111 generates the screen 321 including a warning (step S131). Next, returning to step S105, the operation panel 20 displays the screen 321.

Thus, when the button 304 is not operated for a defined time, the message 325 is displayed as illustrated in the screen 321, and therefore a user can be strongly prompted to replace compression springs.

(4-2) Forced Execution of Lubrication Mode

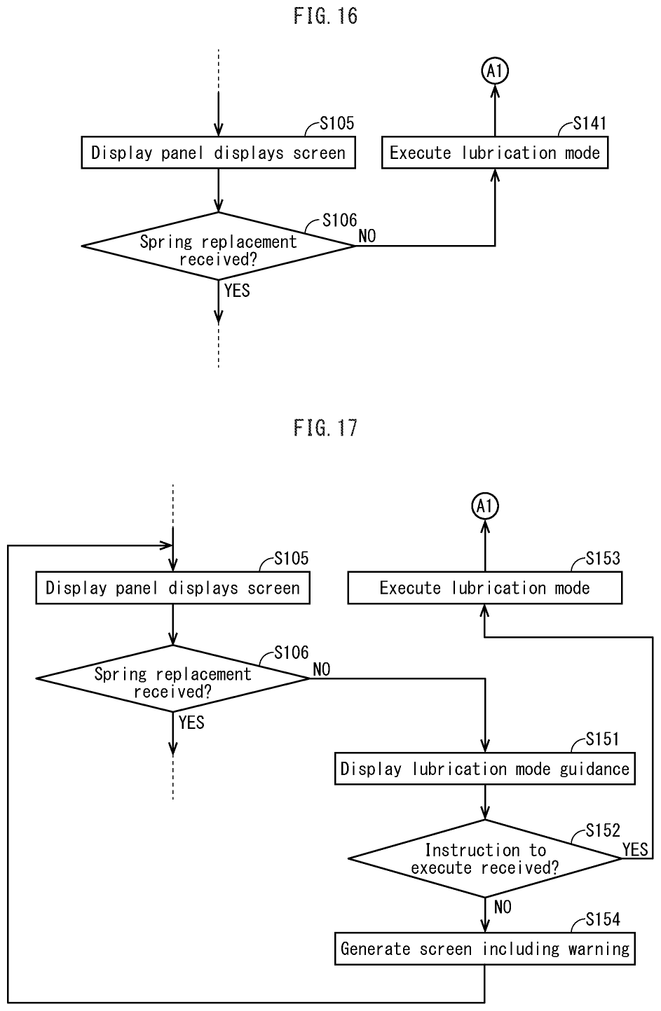

When the display controller 111 generates the screen 301 illustrated in FIG. 6 and the operation panel 20 displays the screen 301, and the button 304 indicating replacement completion is not operated for a defined time, for example 24 hours, the lubrication mode is executed. That is, under the control of the controller 143, the photosensitive drum 413 and the lubrication device 200 of each color component of image forming unit are driven for, for example, 1 minute. Operations of the image forming device 1 in this case are described with reference to the flowchart illustrated in FIG. 16. Here, description is provided focusing on differences from the flowchart illustrated in FIG. 7.

In step S106 of the flowchart illustrated in FIG. 7, when the operation panel 20 does not receive operation of the button 304 indicating compression spring replacement for a defined time (“NO” in step S106), the lubrication mode is forcibly executed. That is, under the control of the controller 143, the photosensitive drum 413 and the lubrication device 200 of each color component of image forming unit are driven for, for example, 1 minute (step S141). Next, processing returns to step S101 of the flowchart illustrated in FIG. 7.

Thus, if the button 304 indicating replacement completion is not operated for a defined time, the lubrication mode is forcibly executed, and therefore even if compression springs are not replaced, a lubricant film of appropriate thickness can be formed on the circumferential surface of the photosensitive drum 413 of each color component of image forming unit.

(4-3) Display of Guidance for Lubrication Mode and Execution of Lubrication Mode

When the display controller 111 generates the screen 301 illustrated in FIG. 6 and the operation panel 20 displays the screen 301, and the button 304 indicating replacement completion is not operated for a defined time, for example 24 hours, guidance for the lubrication mode is displayed, and subsequently the lubrication mode is executed. Operations of the image forming device 1 in this case are described with reference to the flowchart illustrated in FIG. 17. Here, description is provided focusing on differences from the flowchart illustrated in FIG. 7.

In step S106 of the flowchart illustrated in FIG. 7, when the operation panel 20 does not receive an operation of the button 304 indicating replacement of compression springs (“NO” in step S106), the display controller 111 generates the screen 331 including guidance for the lubrication mode as illustrated in FIG. 13, and the operation panel 20 displays the screen 331 (step S151).

Next, if the operation panel 20 receives operation of the button 336a for executing the lubrication mode (“YES” in step S152), the lubrication mode is executed. That is, under the control of the controller 143, the photosensitive drum 413 and the lubrication device 200 of each color component of image forming unit are driven for, for example, 1 minute (step S153). Next, processing returns to step S101 of the flowchart illustrated in FIG. 7.

On the other hand, if the operation panel 20 receives operation of the button 336b for not executing the lubrication mode (“NO” in step S152), the display controller 111 generates a warning screen similar to the screen 321 including a warning illustrated in FIG. 12 (step S154). Next, returning to step S105, the operation panel 20 displays the warning screen.

Thus, if the button 304 indicating replacement completion is not operated for a defined time, guidance for the lubrication mode is displayed, and subsequently, if user consent is obtained, the lubrication mode is executed, and therefore even if compression springs are not replaced, a lubricant film of appropriate thickness can be formed on the circumferential surface of the photosensitive drum 413 of each color component of image forming unit.

(4-4) Display of Lubrication Mode Guidance, Execution of Lubrication Mode, and Changes to Image Forming Conditions

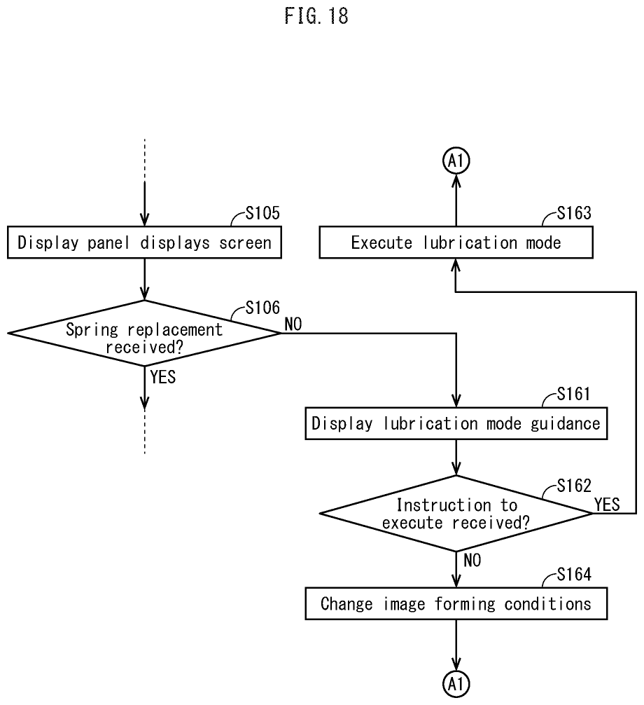

When the display controller 111 generates the screen 301 illustrated in FIG. 6 and the operation panel 20 displays the screen 301, and the button 304 indicating replacement completion is not operated for a defined time, for example 24 hours, guidance for the lubrication mode is displayed, and if user consent is obtained, the lubrication mode is executed. On the other hand, if user consent is not obtained, image forming conditions are changed. Operations of the image forming device 1 in this case are described with reference to the flowchart illustrated in FIG. 18. Here, description is provided focusing on differences from the flowchart illustrated in FIG. 7.

In step S106 of the flowchart illustrated in FIG. 7, when the operation panel 20 does not receive an operation of the button 304 indicating replacement of compression springs (“NO” in step S106), the display controller 111 generates the screen 331 including guidance for the lubrication mode as illustrated in FIG. 13, and the operation panel 20 displays the screen 331 (step S161).

Next, if the operation panel 20 receives operation of the button 336a for executing the lubrication mode (“YES” in step S162), the lubrication mode is executed. That is, under the control of the controller 143, the photosensitive drum 413 and the lubrication device 200 of each color component of image forming unit are driven for, for example, 1 minute (step S163). Next, processing returns to step S101 of the flowchart illustrated in FIG. 7.

On the other hand, if the operation panel 20 receives operation of the button 336b for not executing the lubrication mode (“NO” in step S162), image forming conditions are changed. That is, under the control of the controller 143, when executing image forming, system speed of the print engine 13 and the sheet conveyance unit 50 is changed to, for example, ½ normal system speed. Meanwhile, only the brush roller 201 of the lubrication device 200 of each color component of image forming unit rotates at normal speed (step S164). Next, processing returns to step S101 of the flowchart illustrated in FIG. 7.

As described above, when the button 304 indicating replacement completion is not operated for a defined time, guidance for the lubrication mode is displayed and subsequently, if user consent is not obtained, image forming conditions are changed. When image forming is executed, even when compression springs are not replaced, a lubricant film of appropriate thickness is formed on the circumferential surface of the photosensitive drum 413.

(4-5) Display of Guidance for Lubrication Mode, Execution of Lubrication Mode, Display of Guidance for Change in Image Forming Conditions, and Change in Image Forming Conditions

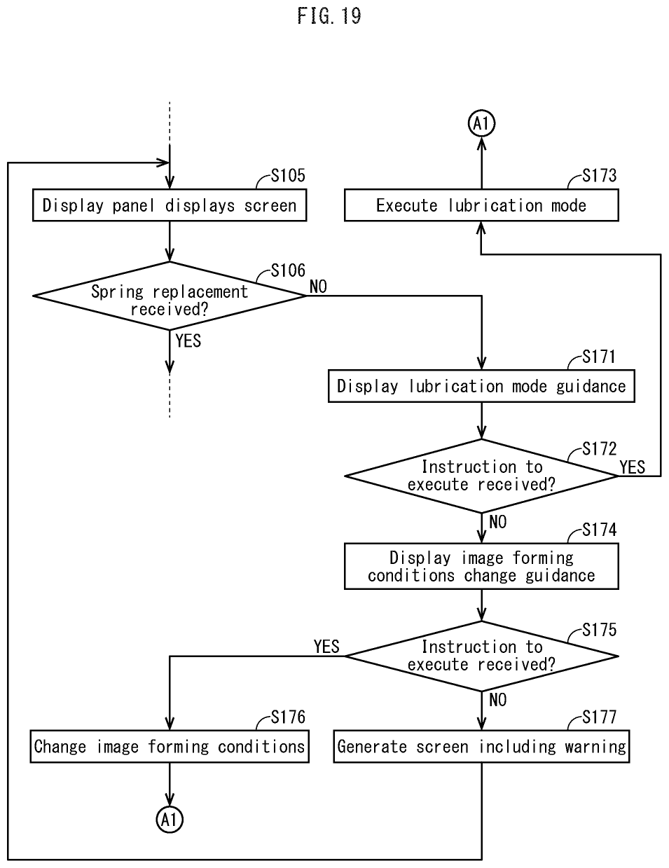

When the display controller 111 generates the screen 301 illustrated in FIG. 6 and the operation panel 20 displays the screen 301, and the button 304 indicating replacement completion is not operated for a defined time, for example 24 hours, guidance for the lubrication mode is displayed, and if user consent is obtained, the lubrication mode is executed. On the other hand, if user consent is not obtained, guidance for a change in image forming conditions is displayed, and if user consent is obtained, image forming conditions are changed. Operations of the image forming device 1 in this case are described with reference to the flowchart illustrated in FIG. 19. Here, description is provided focusing on differences from the flowchart illustrated in FIG. 7.

In step S106 of the flowchart illustrated in FIG. 7, when the operation panel 20 does not receive an operation of the button 304 indicating replacement of compression springs (“NO” in step S106), the display controller 111 generates the screen 331 including guidance for the lubrication mode as illustrated in FIG. 13, and the operation panel 20 displays the screen 331 (step S171).

Next, if the operation panel 20 receives operation of the button 336a for executing the lubrication mode (“YES” in step S172), the lubrication mode is executed. That is, under the control of the controller 143, the photosensitive drum 413 and the lubrication device 200 of each color component of image forming unit are driven for, for example, 1 minute (step S173). Next, processing returns to step S101 of the flowchart illustrated in FIG. 7.

On the other hand, if the operation panel 20 receives operation of the button 336b for not executing the lubrication mode (“NO” in step S172), the display controller 111 generates the screen 341 including guidance for changing image forming conditions as illustrated in FIG. 14, and the operation panel 20 displays the screen 341 (step S174).

Next, if the operation panel 20 receives operation of the button 346a for executing a change in image forming conditions (“YES” in step S175), image forming conditions are changed. That is, under the control of the controller 143, when executing image forming, system speed of the print engine 13 and the sheet conveyance unit 50 is changed to, for example, ½ normal system speed. Meanwhile, only the brush roller 201 of the lubrication device 200 of each color component of image forming unit rotates at normal speed (step S176). Next, processing returns to step S101 of the flowchart illustrated in FIG. 7.

If the operation panel 20 receives operation of the button 346b for not changing image forming conditions (“NO” in step S175), the display controller 111 generates a warning screen like the screen 321 including a warning illustrated in FIG. 12 (step S177). Next, returning to step S105, the operation panel 20 displays the warning screen.

As described above, when the button 304 indicating replacement completion is not operated for a defined time, guidance for the lubrication mode is displayed and subsequently, if user consent is not obtained, guidance for a change in image forming conditions is displayed. If user consent is obtained, then when image forming is executed, even when compression springs are not replaced, a lubricant film of appropriate thickness is formed on the circumferential surface of the photosensitive drum 413.

(2) Forcibly Changing Image Forming Conditions

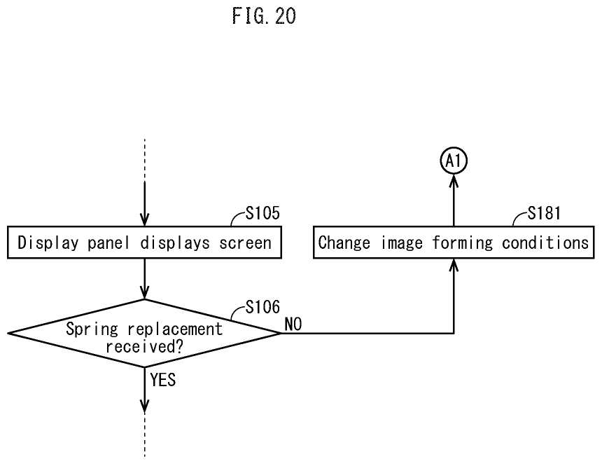

When the display controller 111 generates the screen 301 illustrated in FIG. 6 and the operation panel 20 displays the screen 301, and the button 304 indicating replacement completion is not operated for a defined time, for example 24 hours, image forming conditions are changed. Operations of the image forming device 1 in this case are described with reference to the flowchart illustrated in FIG. 20. Here, description is provided focusing on differences from the flowchart illustrated in FIG. 7.

In step S106 of the flowchart illustrated in FIG. 7, when the operation panel 20 does not receive operation of the button 304 indicating compression spring replacement for a defined time (“NO” in step S106), the change in image forming conditions is forcibly executed. Changing the image forming conditions means that when the image forming device 1 executes image forming, the controller 143 controls a system speed of the print engine 13 and the sheet conveyance unit 50 to be, for example, ½ normal system speed. Meanwhile, only the brush roller 201 of the lubrication device 200 of each color component of image forming unit rotates at normal speed (step S181). Next, processing returns to step S101 of the flowchart illustrated in FIG. 7.

Thus, if the button 304 indicating replacement completion is not operated for a defined time, the change in image forming conditions is forcibly executed, and therefore even if compression springs are not replaced, a lubricant film of appropriate thickness can be formed on the circumferential surface of the photosensitive drum 413 of each color component of image forming unit.

### 4. Other Modifications

Embodiments of the present disclosure are described above, but the present disclosure is not limited to the embodiment described above and includes the following modifications.

(1) According to at least one embodiment, in the lubrication device 200, the solid lubricant 202 is pressed against the brush roller 201 by compression springs so that an amount scraped by the brush roller 201 is constant. According to this structure, the solid lubricant 202 in elongated form is uniformly pressed against the brush roller 201, which also has an elongated form in the axial direction.

In this case, an amount of protrusion of each of the compression springs may be measured when the cover 207 is removed, and a compression spring to be used as a replacement may be selected and used as a replacement by using the protrusion obtained by measurement and the table illustrated in FIG. 9.

(2) According to at least one embodiment, the storage 108b includes an area for storing the spring mounting times 108d for each compression spring of each color component of image forming unit, and the clock 108c adds measured elapsed time to the spring mounting times 108d. When compression springs are replaced, the engine main controller 108a resets the spring mounting times 108d corresponding to the compression springs replaced to initial values of “0 seconds”. The comparison unit 142 compares the spring mounting times 108d to a threshold value, and if one or more of the spring mounting times 108d exceed the threshold value, instructs the display controller 111 to display guidance for replacing the compression springs of the lubrication device 200 that correspond to the spring mounting times 108d that exceed the threshold value.

However, the present disclosure is not limited to this description, and includes the following modifications.

(a) The storage may include an area for storing a cumulative number of rotations of the photosensitive drum 413 for each color component of image forming unit. Further, each image forming unit may include a rotation sensor that detects each rotation of the photosensitive drum 413. Further, the engine main controller 108a may include an addition unit that adds the number of rotations detected by the rotation sensor to the number of rotations stored in the storage 108b. When all of the compression springs are replaced, the engine main controller 108a resets the number of rotations to an initial value of “0”. The comparison unit 142 may compare the number of rotations to a threshold value, and when the number of rotations exceeds the threshold value, the comparison unit 142 may instruct the display controller 111 to display guidance for replacement of all of the compression springs of the lubrication device 200.

The cumulative number of rotations of the photosensitive drum 413 can be considered to be proportional to progress of deterioration of compression springs of the lubrication device 200, and therefore this structure can be considered to detect deterioration of compression springs of the lubrication device 200.

Here, instead of the cumulative number of rotations of the photosensitive drum 413, a cumulative usage time of the photosensitive drum 413 may be used.

(b) Instead of the number of rotations of the photosensitive drum 413, a cumulative number of rotations of the lubrication device 200 may be used to detect deterioration of compression springs of the lubrication device 200.

The storage may include an area for storing the cumulative number of rotations of the brush roller 201 for each color component of image forming unit. Further, each image forming unit may include a rotation sensor that detects each rotation of the brush roller 201. Further, the engine main controller 108a may include an addition unit that adds the number of rotations detected by the rotation sensor to the number of rotations stored in the storage 108b. When all of the compression springs are replaced, the controller 143 resets the number of rotations to an initial value of “0”. The comparison unit 142 may compare the number of rotations to a threshold value, and when the number of rotations exceeds the threshold value, the comparison unit 142 may instruct the display controller 111 to display guidance for replacement of all of the compression springs of the lubrication device 200.

The cumulative number of rotations of the brush roller 201 can be considered to be proportional to progress of deterioration of compression springs of the lubrication device 200, and therefore this structure can be considered to detect deterioration of compression springs of the lubrication device 200.

(c) Deterioration of compression springs of the lubrication device 200 may be detected by using a cumulative number of sheets printed by the image forming device 1.

The storage 108b may include an area for storing the cumulative number of sheets printed by the image forming device 1. Further, the image forming device 1 may include a sensor that detects the number of sheets on which the image forming device 1 forms an image. Further, the engine main controller 108a may include an addition unit that adds a number of sheets detected by the sensor to the cumulative number of sheets printed stored in the storage 108b. When all of the compression springs are replaced, the controller 143 resets the cumulative number of sheets printed to an initial value of “0”. The comparison unit 142 may compare the cumulative number of sheets printed to a threshold value, and when the cumulative number of sheets printed exceeds the threshold value, the comparison unit 142 may instruct the display controller 111 to display guidance for replacement of all of the compression springs of the lubrication device 200.

The cumulative number of sheets printed by the image forming device 1 can be considered to be proportional to progress of deterioration of compression springs of the lubrication device 200, and therefore this structure can be considered to detect deterioration of compression springs of the lubrication device 200.

As described above, the cumulative number of rotations of the photosensitive drum 413, the cumulative number of rotations of the brush roller 201 of the lubrication device 200, and the cumulative number of sheets printed by the image forming device 1 can each be said to be a parameter indicating lubrication performance of the lubrication device 200, similarly to the spring mounting times 108d.

(3) According to at least one embodiment, for each compression spring of each image forming unit, when the button 304 (FIG. 6) is operated, the controller 143 resets the spring mounting times 108d stored in the storage 108b that correspond to the compression spring to the initial value of “0 seconds”.

That is, when operation of the button 304 is received, the controller 143 may, for each compression spring of each image forming unit, write replacement information to the storage 108b, indicating that a compression spring has been replaced.

The controller 143 determines whether the storage 108b stores replacement information for each image forming unit. When replacement information cannot be found for a compression spring, the controller 143 causes display of guidance prompting replacement of the compression spring replacement according to the flowchart illustrated in FIG. 7, or similar.

On the other hand, when replacement information is found for a compression spring, the controller 143 does not execute the procedure of the flowchart of FIG. 7 with respect to the compression spring. That is, once a compression spring is replaced, the corresponding image forming unit no longer causes display of guidance prompting replacement of the compression spring. This is because a compression spring need only be replaced once during the lifetime of an image forming unit, and need not be replaced a second time.

(4) According to at least one embodiment, when the spring mounting times 108d exceed a threshold value, when the cumulative number of rotations of the photosensitive drum 413 exceeds a threshold value, when the cumulative number of rotations of the brush roller 201 exceeds a threshold value, or when the cumulative number of sheets printed by the image forming device 1 exceeds a threshold value, guidance is displayed for replacing compression springs of the application device 200. However, the present disclosure is not limited to these examples.

When the spring mounting times 108d exceed a threshold value, when the cumulative number of rotations of the photosensitive drum 413 exceeds a threshold value, when the cumulative number of rotations of the brush roller 201 exceeds a threshold value, or when the cumulative number of sheets printed by the image forming device 1 exceeds a threshold value, instead of displaying guidance for replacing compression springs of the lubrication device 200 or in addition to displaying guidance for replacing compression springs of the lubrication device 200, the display controller 111 may generate a screen including guidance prompting a change in rotation speed of the brush roller 201, and the operation panel 20 may display the screen. On this screen is displayed an icon to instruct a change in rotation speed of the brush roller 201. When a service person or user operates the icon, the controller 143 controls the brush motor 205 to cause the brush roller 201 to rotate faster than usual during image formation or while waiting for execution of an image forming job.

As a result, more lubricant can be supplied to the photosensitive drum 413.

(5) According to at least one embodiment, the lubricant device 200 supplies lubricant to the photosensitive drum 413, but the image carrier is not limited to a drum shape.

For example, the lubricant device 200 may supply lubricant to a belt-shaped photoconductor (image carrier).

Further, an intermediate transfer body such as the intermediate transfer belt 421 may be regarded as the image carrier, and the lubrication device 200 may supply lubricant thereto. An image forming device may include an intermediate transfer drum as an intermediate transfer body instead of an intermediate transfer belt. In such a case, the lubricant device 200 may supply lubricant to the intermediate transfer drum.

Further, in the case of an image forming device that does not include an intermediate transfer member, a photosensitive drum may be the image carrier and an image on the photosensitive drum may be directly transferred to a sheet. In such a case, the lubricant device 200 may supply lubricant to the photosensitive drum.

As with other examples, when a parameter indicating lubrication performance of the lubrication device 200 exceeds a threshold value, guidance for replacing compression springs of the lubricant device 200 is displayed. If the guidance is followed and compression springs of the application device 200 are replaced, lubrication performance of the application device 200 can be restored.

(6) According to at least one embodiment, the image forming device 1 includes a computer system including a microprocessor and memory. The memory stores a computer program and the microprocessor operates according to the computer program.

The computer program may be stored in a non-transitory computer-readable storage medium such a flexible disk, a hard disk, an optical disk, a semiconductor memory, or the like.

Further, the computer program may be transmitted by a wired or wireless telecommunication line, a network such as the Internet, data broadcasting, or the like.

(7) Any of the embodiments and modifications thereof may be combined.

Although one or more embodiments of the present invention have been described and illustrated in detail, the disclosed embodiments are made for the purposes of illustration and example only and not limitation. The scope of the present invention should be interpreted by the terms of the appended claims

What is claimed is:

1. An image forming device that forms a toner image on an image carrier, comprising:
a lubrication device that applies lubricant to the image carrier;
a display;
a hardware processor and a non-transitory computer-readable recording medium comprising computer-executable instructions that when executed by the hardware processor are configured to cause the image forming device to:
acquire a parameter that indicates lubrication performance of the lubrication device;
compare the parameter to a threshold value; and
when the parameter exceeds the threshold value, display guidance on the display prompting an operation to restore lubrication performance of the lubrication device.

2. The image forming device of claim 1, wherein
the lubrication device comprises:
the lubricant in a form of a solid block;
a lubricant supplier; and
a pressing member that presses the solid block against the lubricant supplier, wherein
the lubricant supplier scrapes the lubricant from a surface of the solid block according to a pressing force of the pressing member and supplies the lubricant to the image carrier.

3. The image forming device of claim 2, wherein
the operation prompted by the guidance is to restore the pressing force of the pressing member.

4. The image forming device of claim 3, wherein
the operation to restore the pressing force of the pressing member is replacing the pressing member.

5. The image forming device of claim 4, wherein
the hardware processor and the recording medium further cause the display to display information indicating a replacement pressing member that has a pressing force proportional to a remaining amount of the solid block as a replacement for the pressing member.

6. The image forming device of claim 4, wherein
the solid block, the lubricant supplier, and the pressing member are housed inside a housing, a wall of the housing has a through hole for removing and replacing the pressing member, the through hole is covered by a removable cover, and the pressing member is sandwiched between the cover when mounted and the solid block.

7. The image forming device of claim 3, wherein
the pressing member is an elastic body.

8. The image forming device of claim 7, wherein
the elastic body is a compression spring.

9. The image forming device of claim 2, wherein
the lubricant supplier is a rotating brush in which brush bristles protrude from a circumferential surface of a cylinder, and
when the lubricant supplier rotates, the brush bristles scrape the lubricant from the surface of the solid block.

10. The image forming device of claim 9, wherein
the hardware processor and the recording medium cause the display to display guidance prompting a change in rotation speed of the rotating brush when the parameter exceeds a threshold value.

11. The image forming device of claim 2, wherein
the image carrier is rotatable, and
the parameter is either a cumulative number of sheets printed by the image forming device, a cumulative number of rotations of the image carrier, or a cumulative usage time of the image carrier.

12. The image forming device of claim 3, further comprising
an input receiver that receives input from a user, wherein
if the input receiver has not received input indicating that a user has restored lubrication performance of the lubrication device for a defined time after the display of the guidance prompting restoration of lubrication performance of the lubrication device, the hardware processor and the recording medium control the lubrication device to supply more lubricant than would be supplied during image forming, in a standby time period in which the image forming device is waiting to receive an instruction to execute image forming.

13. The image forming device of claim 12, wherein
the image carrier is rotatable,
the lubricant supplier is a rotating brush in which brush bristles protrude from a circumferential surface of a cylinder, and
in order to supply more lubricant than would be supplied during image forming in the standby time period, the hardware processor and the recording medium cause the image carrier to rotate at a circumferential speed slower than that used during image forming, and cause the rotating brush to rotate at a circumferential speed equal to that used during image forming.

14. The image forming device of claim 3, further comprising
an input receiver that receives input from a user, wherein
if the input receiver has not received input indicating that a user has restored lubrication performance of the lubrication device for a defined time after the display of the guidance prompting restoration of lubrication performance of the lubrication device, the hardware processor and the recording medium cause the display to display guidance prompting lubrication.

15. The image forming device of claim 14, wherein
if the input receiver has not received input indicating that a user has executed lubrication for a defined time after the display of the guidance prompting lubrication, the hardware processor and the recording medium change image forming conditions.

16. The image forming device of claim 15, wherein
the image carrier is rotatable,
the lubricant supplier is a rotating brush in which brush bristles protrude from a circumferential surface of a cylinder, and
if the input receiver has not received input indicating that a user has executed lubrication for a defined time after the display of the guidance prompting lubrication, the hardware processor and the recording medium cause the image carrier to rotate during image forming at a circumferential speed slower than that used during image forming before the change in image forming conditions, and cause the rotating brush to rotate during image forming at a circumferential equal to that used during image forming before the change in image forming conditions.

17. The image forming device of claim 14, wherein
if the input receiver has not received input indicating that a user has executed lubrication for a defined time after the display of the guidance prompting lubrication, the hardware processor and the recording medium cause the display to display guidance prompting a change in image forming conditions.

18. The image forming device of claim 3, further comprising
an input receiver that receives input from a user, wherein
if the input receiver has not received input indicating that a user has restored lubrication performance of the lubrication device for a defined time after the display of the guidance prompting restoration of lubrication performance of the lubrication device, the hardware processor and the recording medium change image forming conditions.

19. The image forming device of claim 3, further comprising
an input receiver that receives input from a user, wherein
if the input receiver has not received input indicating that a user has restored lubrication performance of the lubrication device for a defined time after the display of the guidance prompting restoration of lubrication performance of the lubrication device, the hardware processor and the recording medium cause the display to display guidance prompting a change in image forming conditions.

20. A control method used in an image forming device that forms a toner image on an image carrier comprising a lubrication device that applies lubricant to the image carrier and a display, the control method comprising:
acquiring a parameter that indicates lubrication performance of the lubrication device;
comparing the parameter to a threshold value; and
when the parameter exceeds the threshold value, displaying guidance on the display prompting an operation to restore lubrication performance of the lubrication device.
